(19) United States
(12) Patent Application Publication
(10) Pub. No.: US 2007/0184166 A1
(43) Pub. Date: Aug. 9, 2007

(54) Frozen or fresh batter mix and cake

(76) Inventors: Phyllis D. Price, Gulf Port, MS (US); Artecia L. Price, Providence, RI (US)

Correspondence Address: Mrs. Phyllis D. Price, 13041 Sweetwater Trail, Gulf Port, MS, 39503, US

(21) Appl. No.: 11/347,727

(22) Filed: Feb. 3, 2006

(51) Int. Cl. A21D 10/00

(52) U.S. Cl. 426/549

(57) ABSTRACT

A batter is described, along with the use of the batter to provide frozen, unbaked cakes which may quickly be baked in an oven. The batter consists preferably of soft wheat flour, salt, granulated sugar, sour cream, cream cheese, butter, eggs and extract flavoring all mixed in proportions that allow for proper freezing and baking. The batter may be baked immediately or frozen batter to be baked later without the need for thawing. The cake is created by putting freshly made batter or frozen batter in a pan in an oven heated to about 300 degrees Fahrenheit for about 1 hour and 15 minutes.

### BACKGROUND OF THE INVENTION

1. Field of Invention

The present invention relates to the food art, and in particular to the preparation of a batter which can be frozen and subsequently baked in an oven without the need for thawing.

2. Description of the prior art

The prior art known to the present invention is quite limited due to the fact that they use chemically leavened batters, added water, added emulsifiers, and added preservatives. These prior art products use conventional ingredients and require thawing when frozen.

It will be needed in the art to provide a convenient, flavorful home-made cake with desirable texture. It can be made from scratch or from a batter that has been frozen and does not need thawing, that is not chemically leavened, and does not contain added water, added emulsifiers, and added preservatives.

### SUMMARY OF THE INVENTION

While this invention is being described in connection with batter which can be frozen and baked into a cake in certain pans, this invention is not to be so limited.

This invention provides a process for preparing batter, freezing batter and baking a cake from the batter without the need for thawing a frozen batter. This invention has no added water as it breaks down the chemical reaction in the ingredients that are used to emulsify the batter. This will result in an inconsistency in the rising of the batter.

### DETAILED DESCRIPTION OF THE INVENTION

The batter is preferably made by mixing 12¼ oz. flour, 11 oz. eggs, 1 lb 5 oz. granulated sugar, ⅜ oz. salt, 12 oz. butter, 8 oz. cream cheese, 3 oz. sour cream, and ⅜ oz. specially formulated extract. The mixing process comprises sifting flour and salt together in a large mixing bowl. In a large mixing bowl on medium speed blend sugar, butter, cream cheese and sour cream until well blended. Further blend mixture on high speed until mixture is fluffy. On low speed, fold in eggs, add extracts and continue beating for about 1 minute. Add the flour and salt mixture and continue beating until mixture is smooth for about 2 minutes. Ingredients yield about 4 lbs batter that can be baked in one pan at about 300 degrees Fahrenheit. For creating frozen batter, this invention preferably has batter frozen within an hour of preparation to maintain maximum freshness. Frozen batter may be transferred to oven with no thawing necessary. Exemplary baking times are about 1 hr 15 mins to 1 hr 30 mins in an electric oven and about 1 hr 15 mins in a gas oven. Pans such as bundt pan or round pan may be used for baking. The batter of another embodiment of this invention may be made by mixing 19% flour, 17% eggs, 29% granulated sugar, 0.25% salt, 18% butter, 12% cream cheese, 4% sour cream, and 0.75% specially formulated extract. The batter of another embodiment of this invention may be made by mixing 3 cups flour, 6 whole eggs, 3 teaspoons granulated sugar, ½ teaspoon salt, 1½ cups butter, I cup cream cheese, ⅓ cup sour cream, and 1 teaspoon specially formulated extract. Another embodiment of this invention may use lemon extract, vanilla extract, or almond extract in addition to, or instead of the specially formulated extract. Another embodiment of this invention may use up to 5% variances of the stated weights, measures and percentage weight in the composition of the batter.

### EXAMPLES

TABLE 1
Ingredients useful for preparing about 4 lbs of cake batter.

| Ingredient | Weight | |
|---|---|---|
| Flour | 12¼ | oz. |
| Salt | ⅜ | oz. |
| Sugar | 1 lb 5 | oz. |
| Sour cream | 3 | oz. |
| Cream cheese | 8 | oz. |
| Butter | 12 | oz. |
| Eggs | 11 | oz. |
| Extract flavoring | ⅜ | oz. |

TABLE 2
Ingredients useful for preparing about 4 lbs of cake batter.

| Ingredient | % by Weight |
|---|---|
| Flour | 19% |
| Salt | 0.25% |
| Granulated sugar | 29% |
| Sour cream | 4% |
| Cream cheese | 12% |
| Butter | 18% |
| Eggs | 17% |
| Extract flavoring | 0.75% |

TABLE 3
Ingredients useful for preparing about 4 lbs of cake batter.

| Ingredient | Measure | |
|---|---|---|
| Flour | 3 | cups |
| Salt | ½ | tsp. |
| Sugar | 3 | tsp. |
| Sour cream | ⅓ | cup |
| Cream cheese | 1 | cup |
| Butter | 1½ | cups |
| Eggs | 6 | whole eggs |
| Extract flavoring | 1 | tsp. |

What is claimed is:

1. A batter comprising:
a mixture of ingredients flour, eggs, sugar, granulated salt, butter, cream cheese, sour cream and extract flavoring.

2. The batter of claim 1, wherein said extract flavoring is selected from the group comprising:
vanilla extract, lemon extract, almond extract, and specially formulated extract flavoring.

3. The batter of claim 1, wherein said flour is soft wheat flour.

4. The batter of claim 1, wherein said ingredients have measurements by weight of 12¼ oz. flour, 1 lb 5 oz. granulated sugar, 11 oz. eggs, ⅜ oz. salt, 12 oz. butter, 8 oz. cream cheese, 3 oz. sour cream, ⅜ oz. extract flavoring.

5. The batter of claim 4, wherein said measurements by weight vary by up to 5%.

6. The batter of claim 1, wherein said ingredients have percentages of 19% flour, 29% granulated sugar, 17% eggs, 0.25% salt, 18% butter, 12% cream cheese, 4% sour cream, 0.75% extract flavoring.

7. The batter of claim 6, wherein said percentages vary by up to 5%.

8. The batter of claim 1, wherein said ingredients have measurements of 3 cups flour, 3 teaspoons granulated sugar, 6 whole eggs, ½ teaspoon salt, 1½ cups butter, 1 cup cream cheese, ⅓ cup sour cream, 1 teaspoon extract flavoring.

9. The batter of claim 8, wherein said measurements vary by up to 5%.

10. A frozen batter comprising said batter of claim 1, wherein said batter is stored at freezing temperatures.

11. A cake comprising said batter of claim 1, wherein said batter is baked in an oven with a temperature of about 300 degrees Fahrenheit, and baking duration of about 1 hour 15 minutes to about 1 hour 30 minutes.

12. A cake comprising said frozen batter of claim 10, wherein said frozen batter is baked in an oven with a temperature of about 300 degrees Fahrenheit, and baking duration of about 1 hour 15 minutes to about 1 hour 30 minutes.
